(19) United States
(12) Patent Application Publication
(10) Pub. No.: US 2003/0053379 A1
(43) Pub. Date: Mar. 20, 2003

(54) Record carrier for storage and reproduction arrangement and storage arrangement for processing data not related to the record carrier

(75) Inventors: Andreas Kitzler, Vienna (AT); Wolfgang Wimmer, Vienna (AT); Alois Homer, Vienna (AT)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/232,734

(22) Filed: Aug. 29, 2002

(30) Foreign Application Priority Data
Aug. 31, 2001 (EP) 01 890 257.7

(51) Int. Cl. G11B 21/08; G11B 7/085

(52) U.S. Cl. 369/30.08

(57) ABSTRACT

In a preferably disc-like scannable record carrier (3) which contains at least one subcode channel, strange data not related to the disc-like record carrier (3) are stored in the at least one subcode channel. A playback device (1) for scanning such a disc-like record carrier (3) includes playback device data processing means (5, 10) which are arranged for processing strange data formed by update data, which update data are transferred to non-volatile memory means (13) for updating a routine of a function unit (12).

The invention relates to a scannable record carrier which contains at least one subcode channel, data being stored in the at least one subcode channel.

The invention further relates to a playback device for playing back data of such a record carrier stored in a subcode channel and to a recording device for recording data in a subcode channel of such a record carrier.

The invention further relates to a recording device for recording a record carrier, there being a possibility for subcode channel data to be stored in at least one subcode channel.

Such a record carrier and such a playback device have been developed and marketed by the applicants and are therefore known. They are a so-termed Audio-Compact disc CD and a so-termed Audio-CD player or CD player, respectively. According to the industrial Audio-CD standard or CD-DA standard (Red Book), respectively, such a CD contains so-termed subcode data channels, which subcode data channels are contained in the so-termed main channel in the time-multiplex mode in the audio data stream. The total of eight (8) existing subcode data channels are referred to as P, Q, R, S, T, U, V and W channels. The data from the subcode data channels enable the CD player to playback additional information, such as, for example, the elapsing time during playback of a track stored on a CD, which elapsing time is stored in the Q subcode channel, or the name of a track and/or the associated interpreters. The great disadvantage with this known data carrier and with the known playback device is that always data relating only to the main channel situated on the record carrier are stored in the subcode channels and, consequently, only such data can be processed. For the known record carrier there are only possibilities of using data relating to the main channel and present on the record carrier for various purposes. This means a limitation bounding, however, the possibilities of use of such a record carrier.

It is an object of the invention to eliminate the above-mentioned limitations and provide an improved record carrier and an improved playback device and an improved recording device.

To achieve the above-mentioned object in a record carrier according to the invention, characteristic features according to the invention are provided so that a record carrier according to the invention can be characterized in the manner defined below, that is:

A record carrier, which record carrier can be scanned and contains at least one subcode channel, data being stored in the at least one subcode channel and the data stored in the at least one subcode channel being formed by strange data not related to the record carrier.

To achieve the object defined above a playback device according to the invention has features according to the invention so that a playback device according to the invention can be characterized in the manner defined below, that is:

A playback device for scanning a record carrier, which record carrier contains at least one subcode channel, data being stored in the at least one subcode channel, the playback device comprising a scanning device for scanning the record carrier and playback data processing means for processing the data stored in the at least one subcode channel, the playback data processing means being arranged for processing strange data not related to the record carrier.

To achieve the object defined above a recording device according to the invention has features according to the invention so that a recording device according to the invention can be characterized in the manner defined below, that is:

A recording device for writing a record carrier on which subcode channel data can be stored in at least one subcode channel, the recording device comprising a writing device for writing the record carrier and recording data processing means for processing data to be stored in the subcode channel, the recording data processing means being arranged for processing strange data not related to the record carrier.

By providing the measures according to the invention an improved record carrier and an improved playback device and an improved recording device are obtained in a simple manner, a very important improvement being that in the subcode channels of the record carrier can be stored data not related to the record carrier, to be called strange data hereinafter, with the improved recording device and can be processed by the improved playback device. Such a system comprising the improved record carrier and the improved playback device enables, for example, an updating of data used in the playback device, which do not consist of data related to the record carrier. The strange data form, for example, update data, thus updated data to control the playback device, with which update data an update of routines executed in the playback device can be effected.

At this point it may be observed that an update possibility of data not related to the record carrier can be effected by a record carrier that meets a so-termed CD-ROM standard, one playback device, however, then being necessary for this case which has to comprise a much more complex and expensive arrangement, which is highly disadvantageous in respect of the attendant circuitry and cost.

Providing the characteristic feature as claimed in claim 3 makes a very simple storage and reading possible of the strange data, because conventional integrated circuits provided for decoding the subcode channels have a separate connection, thus a simple access to the data of the Q subcode channel, so that no additional cost of hardware is necessary.

By providing the characteristic features as claimed in claim 4 or claim 5 or claim 6, respectively, the advantage is offered that finding back the strange data or update data is simplified, because less stringent requirements as to accuracy for the implementation of a positioning of a for example optically working reading unit of the playback device will be sufficient.

A playback device according to the invention as claimed in the claims 8, 9 and 10 and a recording device according to the invention as claimed in claims 11 and 12 are further arranged according to the requirements and advantageously so that they can cooperate with a record carrier as claimed in the claims 3 to 7 as a result of which the advantages inherent in such a record carrier as claimed in the claims 3 to 7 are obtained for the playback device and the recording device according to the invention.

In connection with the playback device as claimed in claim 10 it should further be observed that update data can also be applied with the aid of the updating device to an apparatus external to the playback device in order to be able to execute an updating operation in this external apparatus.

These and other aspects of the invention are apparent from and will be elucidated with reference to the embodiments described hereinafter.

The invention will be further described with reference to an example of embodiment shown in the drawing to which, however, the invention is not limited.

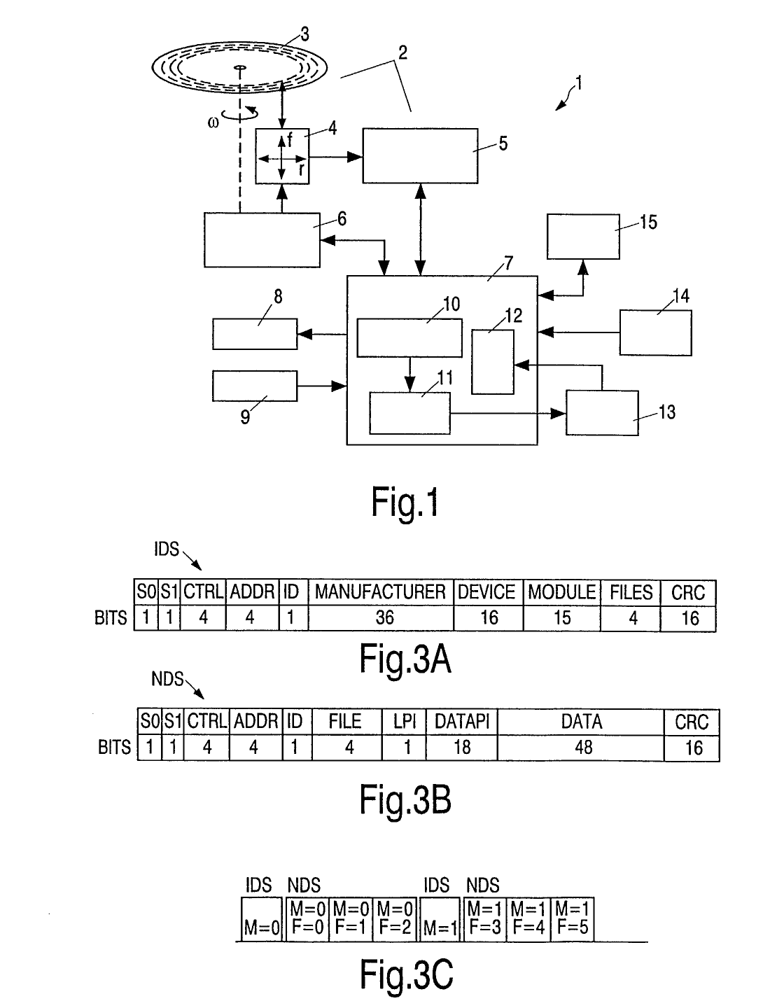

FIG. 1 shows in a diagrammatic manner in the form of a block circuit diagram an essential part of a playback device in the present connection in accordance with an example of embodiment of the invention, which playback device is provided for playing back information digitally stored on a disc-like record carrier that can be read out optically.

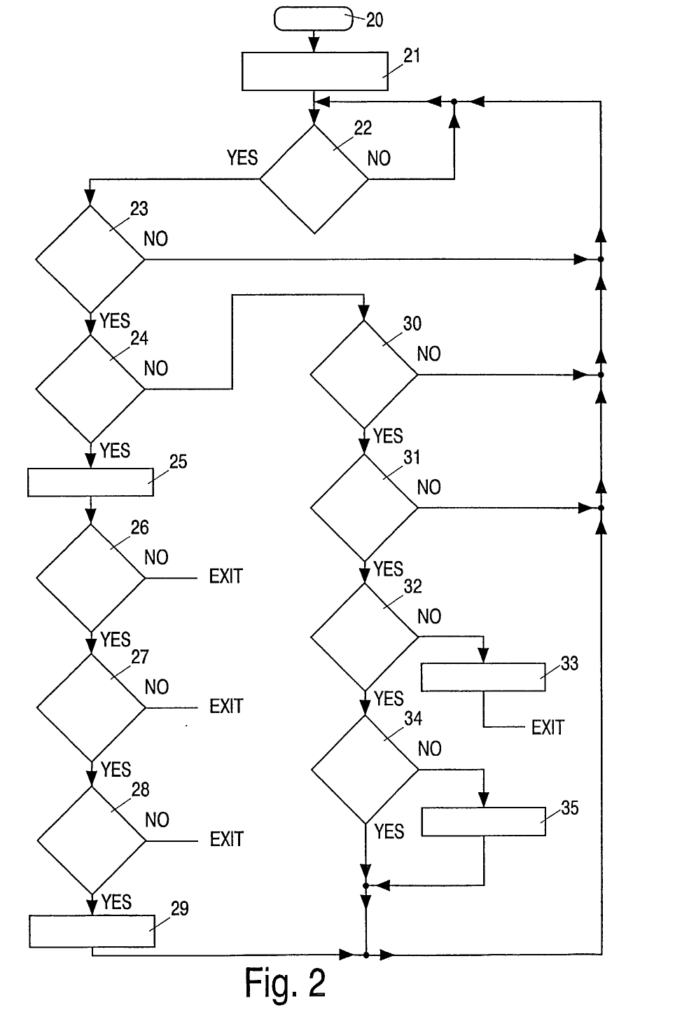

FIG. 2 shows a flow chart of an update routine which can be executed in the playback device as shown in FIG. 1.

FIGS. 3A and 3B schematically show update data which are stored in a subcode channel of an optically readable record carrier and FIG. 3C shows a possible concatenation of the stored update data.

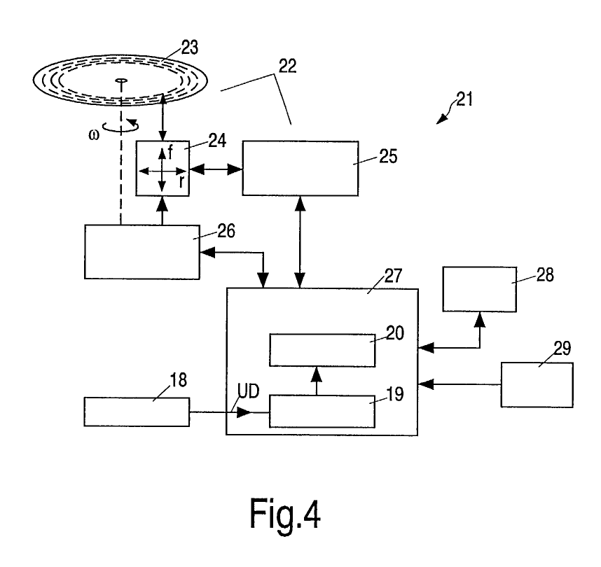

FIG. 4 shows in a diagrammatic manner in the form of a block circuit diagram in the present connection an essential part of a recording device in accordance with an example of embodiment of the invention.

FIG. 1 represents a playback device l.The playback device 1 comprises an optical disc player 2, which optical disc player 2 is provided and arranged for reproducing digitally stored information or data, respectively, which can be read in an optical manner and with a record carrier 3 rotating at an angular velocity ω. The record carrier 3 which can be read optically is in this case in the form of a compact disc CD. The digital information is then stored in tracks on the record carrier 3 in accordance with the CD-DA standard (Red Book). It may be observed that the CD is a so-termed CD-R type or CD-RW type. The information or data, respectively, which is digitally stored on the optically readable record carrier 3 can be read out and transmitted to a decoding circuit 5 by a scanning device, which scanning device may comprise an optical reading unit 4 that can be positioned. The decoding circuit 5 is further provided for error correction. The decoded and error-corrected data are transmitted to a central processing unit (CPU) 7.

The central processing unit (CPU) 7 is coupled to a RAM memory 15, a ROM memory 14 and a non-volatile memory 13. The RAM memory 15 and the ROM memory 14 are provided to control and to process a data stream which is applied to the central processing unit (CPU) 7 from the decoding circuit 5. The non-volatile memory 13 is provided to store update data. The central processing unit (CPU) 7 is further coupled to a servo system 6, which servo system 6 controls the angular velocity o) of the optically readable record carrier 3 as well as the position of the reading unit 4. Control of the reading unit 4 is effected both with respect to the tracks arranged on the record carrier 3, thus radially relative to the optically readable record carrier 3, as this is indicated by the dashed arrow r, and with respect to a focus or focal point, respectively, thus normally relative to the optically readable record carrier 3 as this is indicated by the dashed arrow f. The central processing unit (CPU) 7 further includes subcode date processing means 10, an updating device 11 and a module unit 12. The subcode data processing means 10 are provided to process subcode data, the subcode data are taken from the data that are decoded in the decoding circuit 5. The decoding circuit 5 and the subcode data processing means 10 thus represent an essential part of playback data processing means. The updating device 11 is provided to process and deliver update data to the non-volatile memory means 13. The module unit 12 represents in the present case a speech control module, which speech control module is provided to control the playback device 1 by means of voice commands. The module unit 12 is connected to a non-volatile memory 13 and provided to process the update data stored therein. It may be observed that the module unit 12 may as well be formed by another module unit or functional unit, such as, for example, a tuner unit or an amplifier unit or a CD control unit or a display unit and the like. The central processing unit (CPU) 7 is further connected to display means 8 which in the present case are formed by a display, and to input means 9 which are formed by a keyboard and provided to issue control commands.

In FIGS. 3A and 3B are schematically shown data words or data sequences, respectively, as an example for a possible configuration of update data. FIG. 3A then shows an identification data sequence IDS, which identification data sequence IDS comprises a total of 98 bits and contains the bit blocks S0, S1, CTRL, ADDR, ID, MANUFACTURER, DEVICE, MODULE, FILES and CRC, which have different block lengths as a result of different numbers of bits, as is shown in FIG. 3A. FIG. 3B shows a useful data sequence NDS, which useful data sequence NDS also contains a total of 98 bits, that is the bit blocks S0, S1, CTRL, ADDR, ID, FILE, LPI, DATAPI, DATA and CRC. As is defined in the CD-DA standard, the data words are stored sequentially, thus successively on the optically readable record carrier. In the present case the identification data sequences IDS and the useful data sequences NDS in the Q-subcode channel are stored in the time-multiplex mode in accordance with the CD-DA standard. An identification data sequence IDS is then always stored ahead of a number of useful data sequences NDS, the number of the useful data sequences NDS being determined by a value of the identification data sequence IDS represented in the bitblock FILES. The bit block MANUFACTURER is used for storing identification data specifying a manufacturer, the bit block DEVICE accommodates code data relating to a certain device of the manufacturer, the bit block MODULE stores code data relating to a certain module of the device and the bit block FILES stores a value representing a number of files in which the data are stored for the update. Reference is in this respect made to FIG. 3C by way of explanation in which an example of a series of identification data sequences IDS and useful data sequences NDS for module M is represented by a file index F. In the bit block FILE of the useful data sequence NDS is stored a file index which features the association of the useful data sequence NDS with a certain file. As is evident from FIG. 3C, the file index is continuously incremented for each file, even when a new module follows (the first file of the module 1 begins with the file index F=3). Such an arrangement of data sequences makes a relatively simple positioning of the optical reading unit 4 on a specific file possible.

A file is formed by data packets, a data packet index being stored in the bit block DATAPI of the useful data sequence NDS. The bit LPI of the useful data sequence NDS signals whether the end of a file has been reached. A further explanation hereof is given in conjunction with the description of FIG. 2.

The following description of the bit blocks S0, S1, CTRL, ADDR, ID and CRC holds both for the identification data sequence IDS and for the useful data sequence NDS.

The bit block ID, consisting of one bit, signals whether it is an identification data sequence IDS or a useful data sequence NDS.

The bit block ADDR is used for storing a mode as is provided according to the CD-DA standard. The mode four (4) is chosen here in the present example of embodiment. It may be observed that from the available modes also another mode may be chosen, for example mode 6 or mode 8.

The bit block CTRL contains in accordance with the CD-DA standard a number of audio channels, copy protection information and pre-emphasis information. In the present example of embodiment all the bits of the bit block CTRL are chosen to be logic zero (0).

The bit blocks S0 and S1, which each consist of only one bit, represent synchronisation bits and the bit block CRC represents a check sum in accordance with the CD-DA standard.

In the following a routine is described which routine is executed in the updating device 11 and as a result stores the desired update data in a non-volatile memory.

FIG. 2 shows in the form of a flow chart a routine executed in the playback device 1 as shown in FIG. 1. Said routine is started after being activated by means of a keyboard command from keyboard 9 while the playback device 1 is brought to a so-termed update mode. The change of state may then be displayed on the display 8. It may be observed that said routine may also be started in another way, for example, on the basis of a “self recognition” of the CD, an automatic start of the routine then following once the CD has been recognized by the playback device 1.

As is shown in FIG. 2, the routine is started at a block 20. After block 20 there is an initialization of variables in a block 21. In the present case an identification variable CD_ID is initialized with a logic zero (FALSE), a number-of-files variable NROFFILES, a file-count variable FILECNT and a data packet variable LASTPACKAGE are initialized with a hexadecimal value 0×FF. After the initialization in the block 21 a test is made in block 22 whether a new subcode data block is available in the subcode data processing means 10, the test being repeated until a new subcode data block is available. In a so-termed single speed mode operation of the CD according to the CD-DA standard, a subcode data block is available every 13.3 ms. It may be stated that the CD can also be operated for example in a double speed mode, a subcode data block then being available every 13.3/2 ms. Thus if new subcode data are available, the routine is continued at block 23. At the block 23 a test is made whether the mode value stored in ADDR is equal to a value four (4). In the event of a negative result (NO) of this query, the routine is proceeded with block 22, thus a new subcode data block is waited for. If the test result is positive (YES) at a block 23, block 24 is proceeded with. At block 24 there is a test of the ID bits; when an ID bit is set (logic 1) a block 30 is proceeded with and otherwise a block 25. In the block 25 the identification variable CD_Id is set to logic zero (FALSE) and successively proceeded with a block 26. At the block 26 a test is made whether the value stored in the bit block MANUFACTURER corresponds with a value that is predefined and features a manufacturer. In case of a negative result, thus no correspondence (NO) of this query, the routine is terminated. In case of correspondence, thus a positive result (YES) with the block 26, block 27 is proceeded with. At the block 27 a test is made whether the value stored in the bit block DEVICE corresponds with a value that is predefined and features a device of a manufacturer. In case of a negative result (NO) of this query the routine is terminated. In case of a positive result (YES) at the block 27, block 28 is proceeded with. At the block 28 a test is made whether the value stored in the bit block MODULE corresponds with a value that features a module of a device. In case of a negative result (NO) of this query the routine is terminated. In case of a positive result (YES) at the block 28, block 29 is proceeded with. At the block 29 the identification variable CD_ID is set to logic one (TRUE), the value of the bit block FILES of the identification data sequence IDS is assigned to the number-of-files variable NROFFILES and the file-count variable FILECNT is increased by the value of the bit block FILES of the identification data sequence IDS and subsequently the routine is proceeded at block 22, thus a new subcode data block is waited for.

As has already been observed, the routine is continued at block 30 with a set ID bit (logic 1) during the test at block 24. At the block 30 the logic value of the identification variable CD_ID is tested. If the logic value of the identification variable CD_ID is logic 1 (TRUE) the routine is proceeded with at block 31, otherwise block 22 is proceeded with, thus a new subcode data block is waited for. At block 31 a test is made whether the value of the bit block FILE of the useful data sequence NDS is smaller than the value of the file-count variable FILECNT and larger than a difference between the value of the file-count variable FILECNT and the value of the number-of-files variable NROFFILES. With a positive result of the test at the block 31, the routine is continued at a block 32, otherwise at the block 22. At the block 32 the logic value of the LPI bit of the useful data sequence NDS is tested. If the logic value of the LPI bits is logic 1 (TRUE), the routine is continued at a block 33, otherwise it is continued at a block 34. At block 34 a test is made whether the data packet variable LASTPACKAGE is equal to the value of the bit block DATAPI of the useful data sequence NDS. In case of a negative result (NO) of this query at block 34 the routine is continued at a block 35, otherwise a new subcode data block is waited for again at the block 22. At the block 35 the value of the data packet variable LASTPACKAGE is incremented by unity (1) and the data of the bit block DATA of the useful data sequence NDS, which data of the bit block DATA finally represent the effective updata data, are buffered in the RAM memory 15. Ultimately, at block 33 which is executed when block 32 shows a negative result (NO) all the data buffered in the RAM memory 15 of the data of the bit block DATA of the useful data sequence NDS received thus far are transmitted to the non-volatile memory 13 and subsequently the routine is terminated.

FIG. 4 shows a recording device 21. The recording device 21 comprises an optical disc recording system 22, which optical disc recording system 22 is provided to write a record carrier 23 that can be optically recorded and rotates with an angular velocity ω. The record carrier 23 is prefereably a CD-R or CD-RW. It may be stated that the record carrier 23 may also be a so-termed glass master which is used in a so-termed mastering and replication process for manufacturing pressed CDs, as this is known in expert circles. The recording device 21 comprises a positionable writing device 24 with the aid of which it is possible to store digital information or data, respectively, according to the CD-DA standard (Red Book or Orange Book, respectively, extended for CD-R/RW) on the record carrier 23, and a recording device control unit 25 connected to the optical recording device 24. The data to be stored are conveyed from a central processing unit 27 to the writing device control unit 25.

The central processing unit (CPU) 27 comprises a CD data coding device 20 as well as subcode data generation means 19 and is connected to a RAM memory 28 and a ROM memory 29. The RAM memory 28 and the ROM memory 29 being connected to the central processing unit (CPU) 27 are provided to control the storing of digital information on the record carrier 23. The central processing unit (CPU) 27 is further coupled to a servo system 26, which serve system 26 controls the angular velocity ω of the optically readable record carrier 23 as well as the position of the optical recording device 24.

The CD data coding device 20 and the subcode data generation means 19 form the essential part of recording device data processing means for processing data to be stored in a subcode channel. The recording device 21 further includes update data generation means 18 which are provided and arranged for generating of preparing, respectively, update data UD in accordance with the data blocks indicated in the FIGS. 3A and 3B. The update data UD are delivered, for example, as ASCII data to the subcode data generation means 19, in which subcode data generation means 19 the update data UD are converted so that they can be stored in the Q subcode channel in accordance with the CD-DA standard. The reference to the CD-DA standard is only to be understood with respect to the generation or interleaving and coding. It should be observed that instead of the Q subcode channel in equal manner any other available subcode channel, for example, the P subcode channel can be used for the storage. The update data converted to subcode data are delivered to the CD data coding device 20 in which CD data coding device 20 then follows a coding into so-termed frames and blocks in accordance with the CD-DA standard. In the main channel defined according to the CD-DA standard an audio silence is additively stored. It may be stated that instead of audio silence also a track or audible advertising may be stored.

1. A record carrier (3, 23), which record carrier (3, 23) can be scanned and contains at least one subcode channel, data being stored in the at least one subcode channel and the data stored in the at least one subcode channel being formed by strange data not related to the record carrier (3, 23).

2. A record carrier (3, 23) as claimed in claim 1 wherein the strange data are formed by update data, which update data can be applied to an update device (11) included in a playback device (1) for scanning the record carrier (3, 23).

3. A record carrier (3, 23) as claimed in claim 1 or claim 2 wherein the strange data are stored in a Q-subcode channel.

4. A record carrier (3, 23) as claimed in claim 2 or claim 3 wherein the strange data comprise identification data sequences (IDS) and data sequences (NDS) associated to the identification data sequences (IDS), an identification data sequence (IDS) being stored before an associated data sequence (NDS).

5. A record carrier (3, 23) as claimed in claim 4 wherein immediately after the stored identification data sequence (IDS) this identification data sequence (IDS) is additionally stored repeated at least once.

6. A record carrier (3, 23) as claimed in claim 4 or claim 5 wherein at least part of the data sequences (NDS) associated to the identification data sequences (IDS) is stored at least once more.

7. A record carrier (3, 23) as claimed in claim 1 wherein the record carrier (3, 23) is designed in a disc-like form and can be scanned optically.

8. A playback device (1) for scanning a record carrier (3, 23), which record carrier (3, 23) containing at least one subcode channel, data being stored in the least one subcode channel, the playback device (1) including a scanning device (4) for scanning the record carrier (3, 23) and playback data processing means (5, 10) for processing the data stored in the at least one subcode channel, the playback data processing means (5, 10) being provided to process strange data not related to the record carrier (3, 23).

9. A playback device (1) as claimed in claim 8 wherein the playback device data processing means (5, 10) are arranged for processing update data provided as strange data and in which the updating device (11) is provided, to which updating device (11) the update data processed and delivered by the playback data processing means (5, 10) can be applied.

10. A playback device (1) as claimed in claim 8, wherein storage means (13) are provided to which storage means (13) the update data are applied with the aid of the updating device (11).

11. A recording device (21) for writing a record carrier (3, 23), in which record carrier (3,23) subcode channel data can be stored in at least one subcode channel, the recording device (21) comprising a writing device (24) for writing the record carrier (3, 23) and recording device data processing means (19, 20) for processing of the data to be stored in the subcode channel, the recording device data processing means (19, 20) being arranged for processing strange data not related to the record carrier (3, 23).

12. A recording device (21) as claimed in claim 11, wherein the recording device data processing means (19, 20) being arranged for processing update data provided as strange data.
